(19) United States
(12) Patent Application Publication
(10) Pub. No.: US 2012/0063135 A1
(43) Pub. Date: Mar. 15, 2012

(54) CIRCUIT BOARD FOR AN LED LUMINAIRE

(75) Inventors: Pavel JURIK, Postredni Becva (CZ); Josef Valchar, Postredni Becva (CZ)

(73) Assignee: ROBE LIGHTING S.R.O.

(21) Appl. No.: 13/052,089

(22) Filed: Mar. 20, 2011

Related U.S. Application Data
(60) Provisional application No. 61/381,679, filed on Sep. 10, 2010.
(60) Provisional application No. 61/438,161, filed on Jan. 31, 2011.

(51) Int. Cl. F21S 4/00

(52) U.S. Cl. 362/249.02

(57) ABSTRACT

Disclosed is an LED light source automated luminaire with a LEDs mounted on a partitionable circuit board. The partitionable circuit board allows for less expensive service cost while maintaining lower costs of manufacture of the luminaire.

### RELATED APPLICATION

This application is a utility filing claiming priority of provisional applications 61/381,679 filed on 10 Sep. 2010 and 61/438,161 filed on 31 Jan. 2011.

### TECHNICAL FIELD OF THE INVENTION

The present invention generally relates to a luminaire, specifically to a circuit board for a luminaire utilizing an LED light source.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will typically provide control over the pan and tilt functions of the luminaire allowing the operator to control the direction the luminaire is pointing and thus the position of the light beam on the stage or in the studio. This position control is often done via control of the luminaire's position in two orthogonal rotational axes usually referred to as pan and tilt. Many products provide control over other parameters such as the intensity, color, focus, beam size, beam shape and beam pattern. Additionally it is becoming common to utilize high power LEDs as the light source in such luminaires and, for color control, it is common to use an array of LEDs of different colors. For example a common configuration is to use a mix of Red, Green and Blue LEDs. This configuration allows the user to create the color they desire by mixing appropriate levels of the three colors. For example illuminating the Red and Green LEDs while leaving the Blue extinguished will result in an output that appears Yellow. Similarly Red and Blue will result in Magenta and Blue and Green will result in Cyan. By judicious control of the LED controls the user may achieve any color they desire within the color gamut set by the LED colors in the array. More than three colors may also be used and it is well known to add an Amber or White LED to the Red, Green and Blue to enhance the color mixing and improve the gamut of colors available. The products manufactured by Robe Lighting such as the REDWash 3.192 are typical of the art.

FIG. 1 illustrates a typical LED luminaire 1. These typically contain on-board an array of LEDs 4, mounted in a head 2 and electric motors coupled to mechanical drives systems and control electronics (not shown). In addition to being connected to mains power either directly or through a power distribution system (not shown), each luminaire is connected is series or in parallel through a data link to one or more control desks (not shown).

In a prior art luminaire the array of LEDs 4 may typically be mounted on a single large circuit board 6 forming the output panel in head 2. Such a circuit board when assembled with the array of LEDs 4 is an expensive and complex component of the luminaire 1. If, when in use, any of the LEDs 4 fail in operation then the user may have to replace the entire circuit board with all its LEDs 4, the majority of which are still fully operational, in order to effect a repair to a single LED 4. However, if the manufacturer utilizes multiple smaller circuit boards to mount the LEDs then there will be increased manufacturing costs due to the handling, assembly, and manufacturing costs of dealing with multiple boards as compared to the economic single large board.

This is a need for a circuit board system for an LED luminaire which provides economic service and repair without losing the advantages of a single large board.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical LED luminaire;

FIG. 2 illustrates a luminaire with an embodiment of a partitionable LED circuit board;

FIG. 3 illustrates the detail of an LED circuit board of an embodiment of the LED luminaire illustrated in FIG. 2;

FIG. 4 illustrates a partitioned view of the LED circuit board of illustrated in

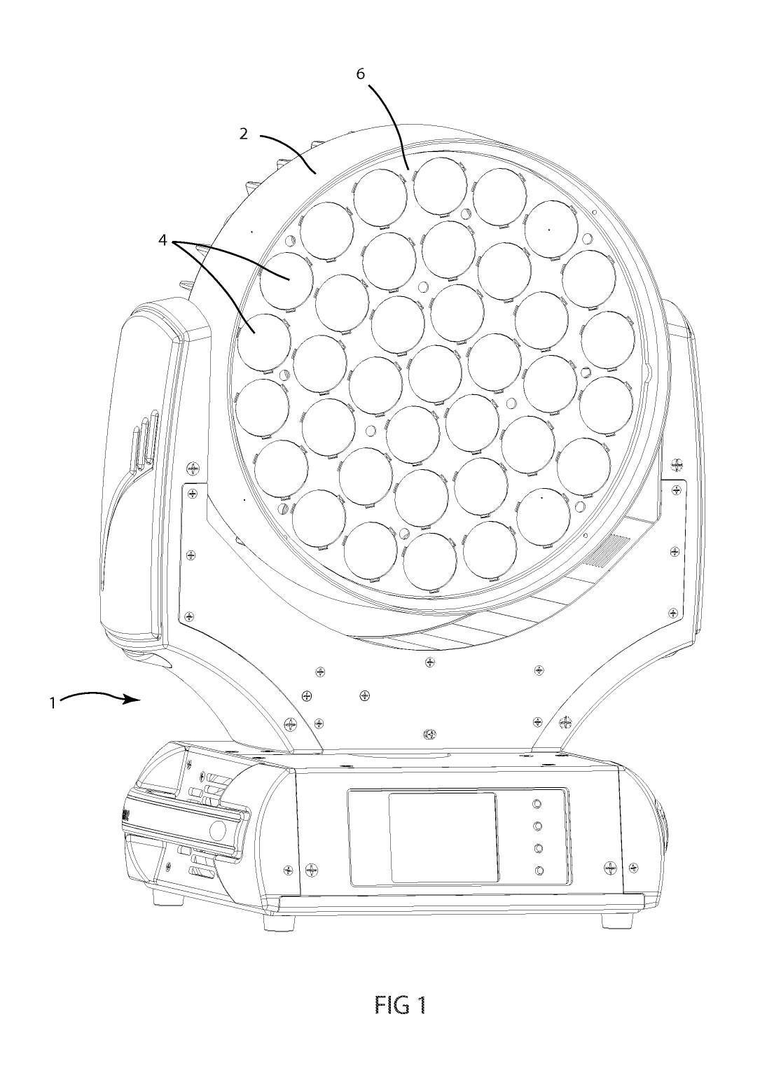

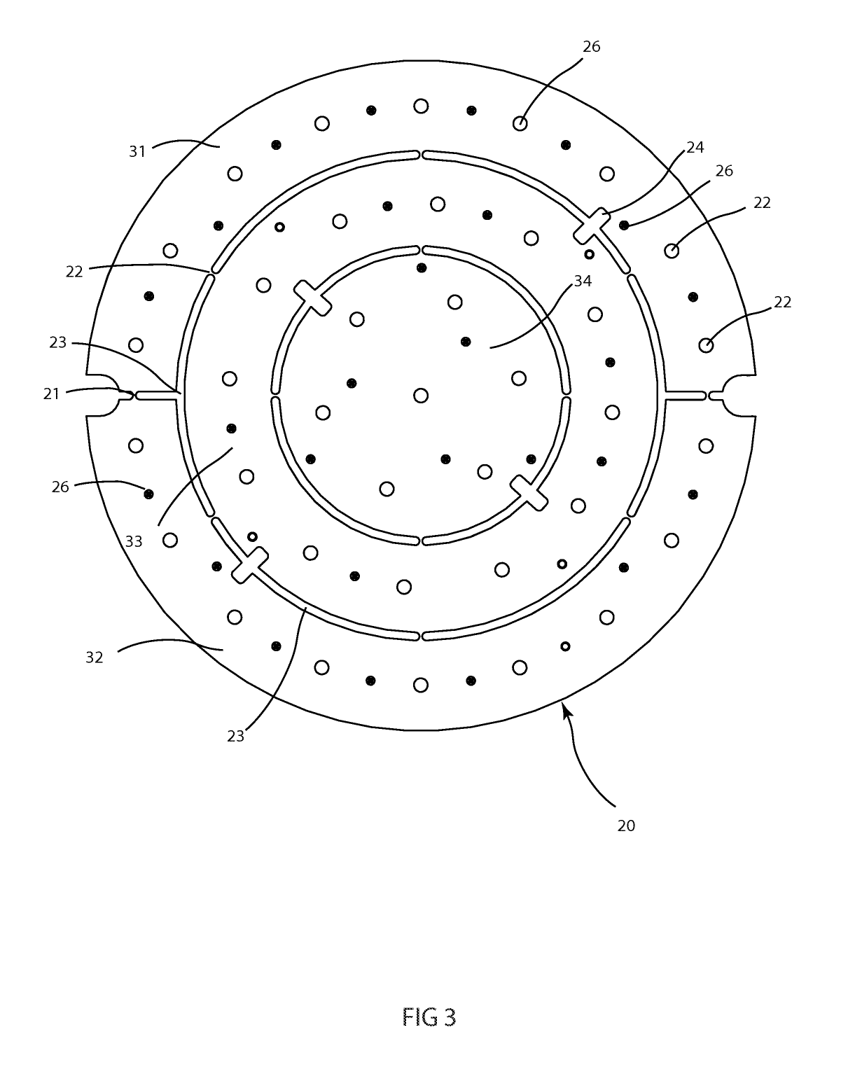

FIG. 3;

FIG. 5 illustrates two connected partitions of the LED circuit board illustrated in FIG. 3;

FIG. 6 illustrates an alternative embodiment of electrical connections of the partitions of the partitionable LED circuit board;

FIG. 7 illustrates the CIE 1931 chromaticity space with Planckian locus; and,

FIG. 8 illustrates strobe and control zones of an embodiment of the invention.

### DETAILED DESCRIPTION OF THE DISCLOSURE

Preferred embodiments of the present disclosure are illustrated in the FIGUREs, like numerals being used to refer to like and corresponding parts of the various drawings.

The present disclosure generally relates to a luminaire, specifically to a circuit board for a luminaire utilizing LED light sources.

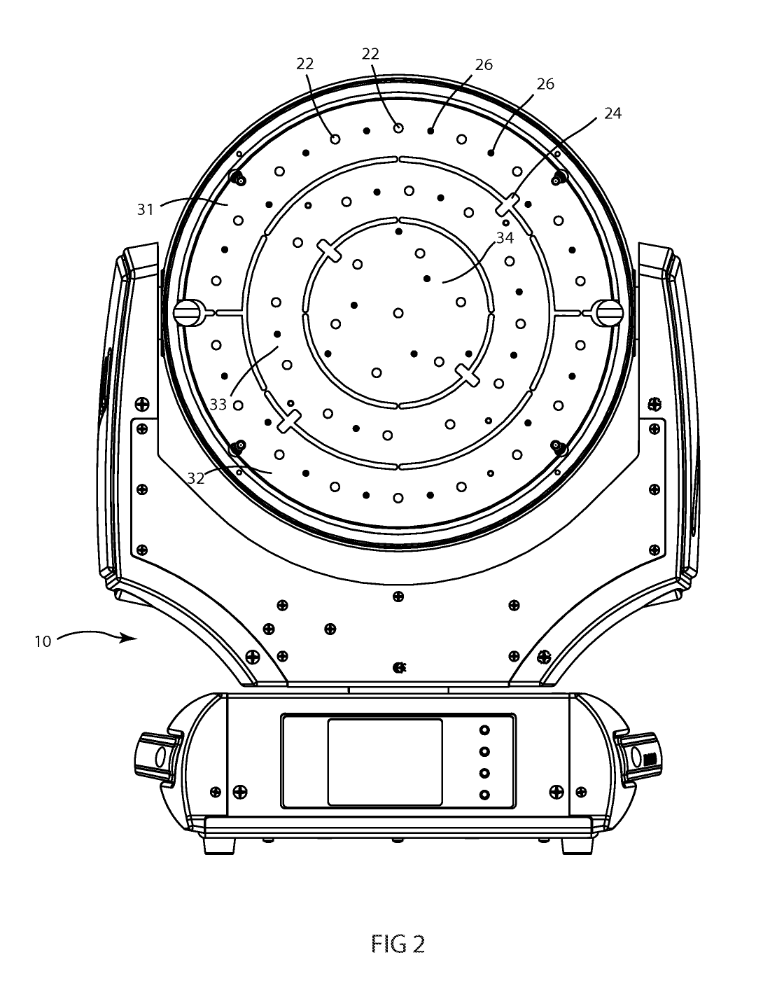

FIG. 2 illustrates the circuit board used in an embodiment of the disclosed LED luminaire. LED luminaire 10 contains a main LED circuit board assembly 20 comprising sub-boards/partitions 31, 32, 33, 34. For clarity of the invention, the LEDS themselves are not shown in their mounting locations 22 in the Figure. It should be appreciated that the LED's are distributed on the sub boards 31, 32, 33 and 34. It should also be appreciated that the invention is not limited to LED's but would apply equally well to any board mounted light emitting device(s) such as OLEDs. Sub-boards 31, 32, 33 and 34 are manufactured as a single board from one piece of circuit board material. During the initial manufacturing stages the traces (not shown) are etched onto, and various layers of materials are plated or printed on to the board using normal printed circuit board techniques well known to those skilled in the art. Throughout these manufacturing stages sub-boards 31, 32, 33 and 34 remain connected as a single circuit board and thus can utilize all the advantages of handling and manufacturing time associated with producing a single circuit board. As a stage of the circuit board manufacturing process the single board is routed to produce the final shape along with any desired mounting holes 26, cable access holes 24 and so on. As part of this process the sub-boards 31, 32, 33 and 34 would normally be completely separated from each other, however, in the disclosed LED luminaire, this separation is deliberately left incomplete and small tabs are left that continue to connect the sub-boards into a single large board and allow continued handling and assembly as if it were a single board.

FIG. 3 illustrates in more detail the partitionable Circuit board 20. The circuit board 20 is formed with separations 23 to form sub-boards/partitions 31, 32, 33 and 34 which remain connected via tabs 21 and 22 so that the sub-boards 31, 32, 33 and 34 remain single board assembly 20. The embodiment shown includes apertures for cable access 24 and mounting holes 26. In later stages in the manufacturing process, circuit board 20 may be populated with LEDs (not shown) and other components (not shown) using standard circuit board population equipment. This process is commonly called ‘stuffing’ the circuit board. The circuit board 20 is stuffed as a single board as all sub-boards 31, 32, 33 and 34 remain connected to each other through their tabs 21 22. Finally, the finished circuit board assembly, complete with all components and connections, may be assembled/installed into the LED luminaire. Again, this process occurs with the boards a single component. Thus, all the way through manufacturing, circuit board 20 has been treated, manufactured, assembled, stuffed and utilized as a single board thus enjoying the benefits in costs and handling affording a single board.

If, during the course of normal use, a component fails on circuit board 20 and it is necessary to replace the board, the user has no need to replace the entire board 20. At this point the service engineer may remove board 20, identify the location of the failed component and snap off the appropriate sub board 31, 32, 33 and 34 from the assembly 20. Thus each of the sub-boards 31, 32, 33 and 34 may be individually replaced as service components at a much lower cost to the manufacturer and user.

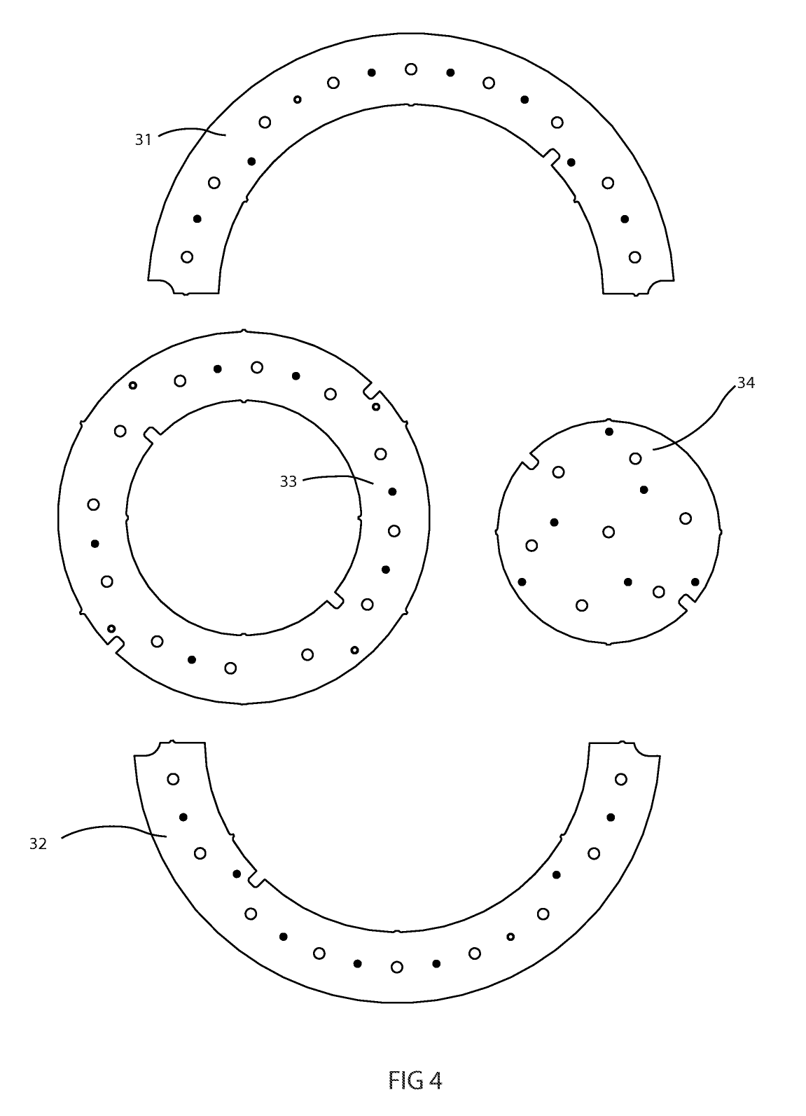

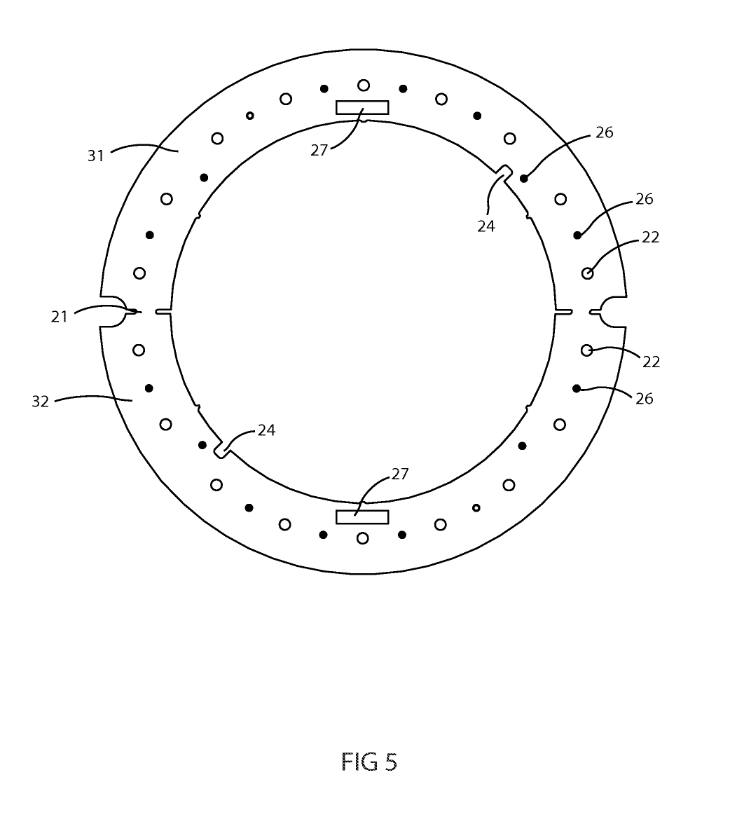

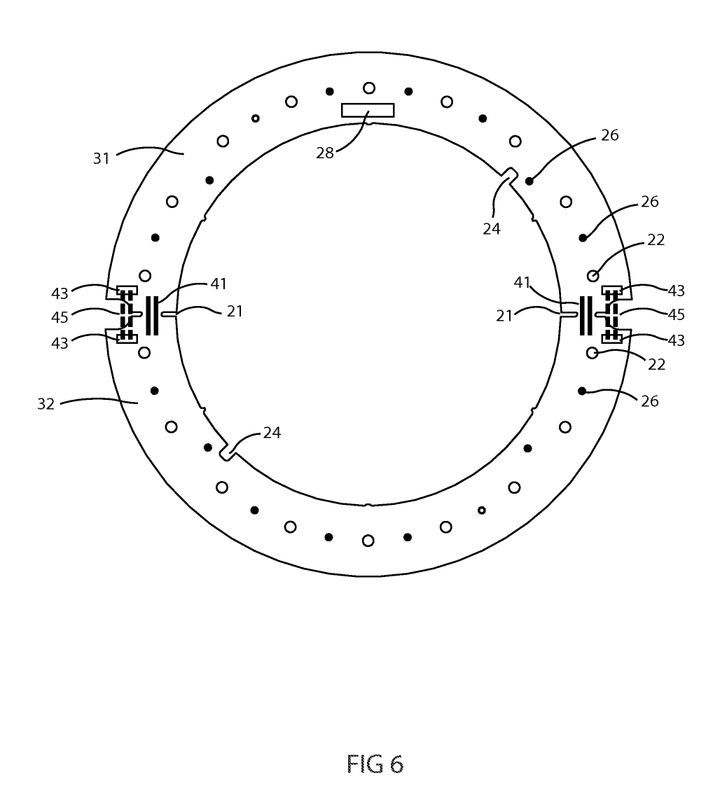

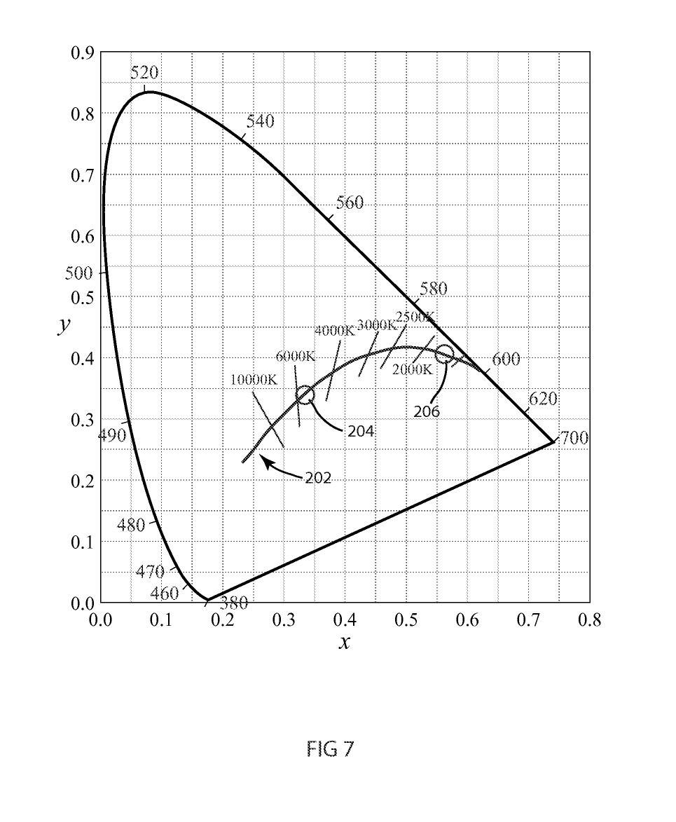

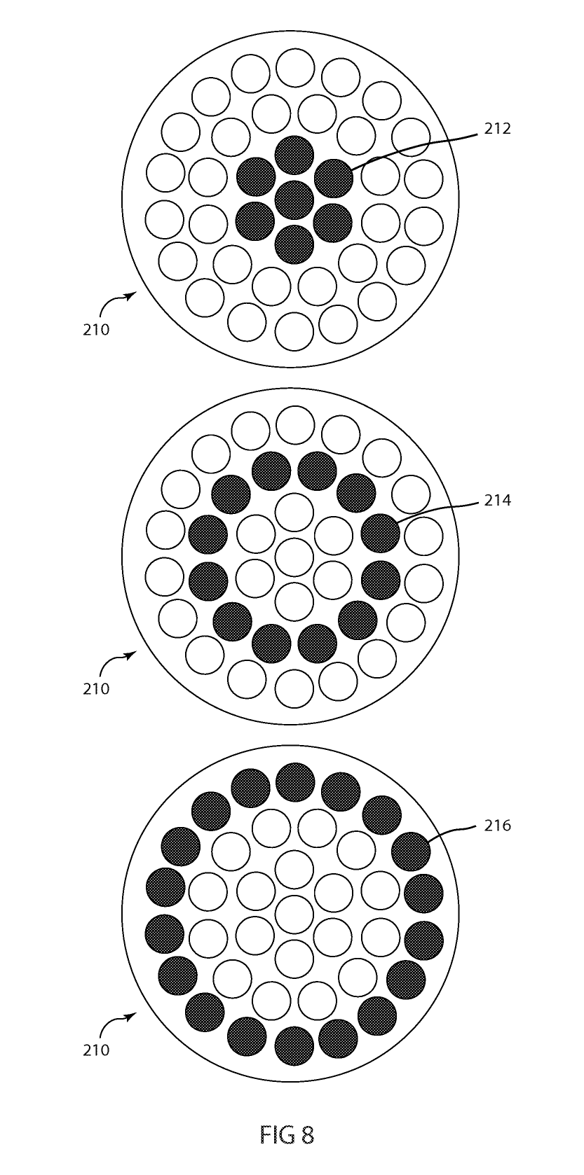

FIG. 4 illustrates circuit board 20 after it has been completely separated into its sub-boards 31, 32, 33 and 34. Each of sub-boards 31, 32, 33 and 34 can be made available as a separate service component.

In a further embodiment of the disclosed LED luminaire control of the LEDs mounted on circuit board 20 may either be with all LEDs on all sub-boards controlled in a combined and coordinated manner or, alternatively, each sub-board may be controlled separately and individually. For example the user may desire that all LEDs on all sub-boards are the same color and brightness, or he may wish the outer ring comprising sub-boards 31 and 32 to be a first color and brightness, the second ring comprising sub-board 33 to be a second color and brightness, and the center ring comprising sub-board 34 to be a third color and brightness.

FIG. 5 illustrates a further embodiment of a circuit board used in the disclosed LED luminaire. Sub-boards 31 and 32 connected through tabs 21 may be fitted with separate electrical connectors 27 where each connector 27 may provide data and power signals for its respective sub-board. Though not shown in this figure, the other sub-boards may also have their own connectors.

FIG. 6 illustrates a further embodiment of a circuit board used in the disclosed LED luminaire where sub-boards share an electrical connector. Sub-boards 31 and 32 connected through tabs 21 and share a common electrical connector 28 on sub-board 31 where connector 28 may provide data and power signals for both sub-boards 31 and 32. Electrical traces 41 across tabs 21 may provide electrical connections from sub-board 31 to sub-board 32 such that sub-board 32 may utilize connector 28. This provides simple manufacture of the product with a single board and a single connector. If, during the course of normal use, a component fails on either sub-board 31 or 32 and it is necessary to replace one of the sub-boards then the two sub-boards will be separated at tabs 21 and electrical traces 41 will be broken. As part of the repair procedure, in order to electrically re-connect sub board 31 and sub-board 32, the service engineer may connect wiring 45 between provided points 43. Such connection may either be via soldered connections or plug connections or any other means of electrical connection well known in the art.

Although the figures and description herein describe an embodiment utilizing a round circuit board that separates into four sub-boards, the disclosure is not so limited and any shape of circuit board with any number of sub-boards may be utilized without departing from the spirit of the disclosure. Further, even though the embodiments described consider an automated LED luminaire the same system may be used for non-automated LED luminaires or other products.

In a further embodiment the disclosed LED based luminaire may be adjusted so as to produce white light by suitable combinations of intensities of colored light from LED modules 106. For example red, green and blue LEDs may be mixed to form a white light by choosing appropriate levels for each of the three colors. The color temperature of the white light produced may be selected from a range as illustrated by line 202 on the standard CIE 1931 chromaticity space as illustrated in FIG. 7. The range of white light points of different color temperatures are shown on such a diagram by the curved line 202 is well known as the Planckian Locus or Black Body Line. Specific points on the Planckian locus are defined by the color temperature at that point, where the color temperature is the temperature in Kelvin (K) that a theoretically perfect black body would have to be to emit the same radiation spectrum. For example, an incandescent lamp may have a color temperature of 3,200K which indicates that the white light radiation from it is the same as that emitted from a perfect black body heated to 3,200K. Color temperatures of white light may range from the very high, blue, end of the Planckian locus at 10,000K or more down to the very low, red, end at 1,000K or less. As an incandescent lamp is dimmed from full output to blackout its color temperature will drop and its color point will tend to move along the Planckian locus. This is familiar as the well-known phenomenon of an incandescent lamp getting redder as it dims. For example a lamp whose color temperature is 5,600K (as shown by point 204 in FIG. 7) may be dimmed in output and its color temperature may drop to around 1,500K (as shown by point 206 in FIG. 7). Although LED emitters do not naturally exhibit this phenomenon as they are dimmed, the described embodiment simulates such a color temperature shift by continuously varying the intensity mix of colored light from LED modules 106 so as to produce white light of the appropriate color temperature. Such a simulation in the change of color temperature as the luminaire is dimmed allows the LED luminaire to emulate the appearance of an incandescent luminaire. The desired combinations of the colored LED emitters necessary to produce white light of any required color temperature along the Planckian locus may be stored in a look-up table within the luminaire or calculated as needed from calibration parameters. To further improve the simulation of an incandescent light source by the disclosed LED luminaire further embodiments of the invention may also include a delay in the intensity control so as to simulate the thermal lag of an incandescent filament. When the power being supplied to an incandescent bulb is altered, the resultant light level emitted from the lamp doesn't immediately change to follow the power change. Instead there is a slight delay as the filament in the lamp either heats up or cools down until it reaches its new equilibrium. This delay, or thermal lag, is familiar to users of incandescent products and appears natural, thus the very rapid control of LED based luminaires, which follow power changes with almost no lag, can appear unnatural and mechanical. In the described invention means are provided, either through software or through electrical circuitry, to simulate this thermal lag by regulating the power supplied to the LED emitters so as to mimic the heat up and cool down delay of an incandescent filament.

FIG. 8 illustrates the strobe and control zones of an embodiment of the invention. In one embodiment of the invention the LED modules 106 are arranged in rings or control zones. FIG. 8 shows luminaire 210 with control zones 212, 214 and 216. These rings or control zones may correlate with circuit boards 31 and 32 (combined as 216), 33 (214) and 34 (212) in FIG. 3. Although three control zones are herein illustrated the invention is not so limited and any number and shape of control zones may be utilized. It is common in automated LED luminaires to provide a single strobe control channel for the entire luminaire such that varying speeds and styles of strobing may be selected for the luminaire. In one embodiment of the invention the luminaire is instead provided with a number of strobe control channels, one for each zone. Each of the control zones 212, 214 and 216 may be controlled individually and independently of the other control zones. In particular a different strobe speed and style may be applied to each of the control zones. These styles and speeds may further be coordinated such that a pleasing overall effect is obtained automatically. Strobe styles may be selected from a list comprising but not limited to; simple strobe, snap-ramp strobe, ramp-snap strobe, ramp-ramp strobe, random strobe, flicker strobe and other strobe styles known in the art. In yet further embodiments the overall synchronization of control zones may be coordinated through an additional master strobe channel and associated macros.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. An LED luminaire with a plurality of light emitting components mounted on a partitionable circuit board.
